(19) United States
(12) Patent Application Publication
(10) Pub. No.: US 2015/0191114 A1
(43) Pub. Date: Jul. 9, 2015

(54) STRAP-RETAINING MECHANISM AND STRAP ASSEMBLY CONTAINING SAME

(71) Applicant: OUTDOOR TECHNOLOGY GROUP, LLC, WINDOM, MN (US)

(72) Inventor: WAYNE BLANKENSHIP, LESLIE, MO (US)

(73) Assignee: OUTDOOR TECHNOLOGY GROUP, LLC, WINDOM, MN (US)

(21) Appl. No.: 14/589,691

(22) Filed: Jan. 5, 2015

Related U.S. Application Data
(60) Provisional application No. 61/923,757, filed on Jan. 5, 2014.

(51) Int. Cl. B60P 7/08; A44B 11/06

(52) U.S. Cl. CPC B60P 7/0838; A44B 11/065

(57) ABSTRACT

A strap assembly having a least one strap or belt secured to a retaining mechanism. The retaining mechanism includes a cinch clamp configured to enable the length of a tensioned portion of one of the straps to be manually adjusted and a tensioning lever engaged with one of the straps configured to move the strap a distance when the lever is moved from a first position to a second position to adjust the length of a tensioned portion of the strap.

### CROSS-REFERENCE TO RELATED APPLICATIONS

This is a non-provisional application claiming priority to provisional application U.S. 61/923,757 filed Jan. 5, 2014, which is hereby incorporated by reference.

### STATEMENT REGARDING FEDERALLY SPONSORED RESEARCH OR DEVELOPMENT

Not Applicable.

### BACKGROUND OF THE INVENTION

1. Field of the Invention

The present invention relates to straps for use in securing items in place, and, more specifically, relates to a retaining mechanism for cinching a strap tightly against or around one or more items and to a strap assembly including such a retaining mechanism.

2. Description of Related Art

It is well known in the art to utilize straps or belts to secure objects and/or people in a fixed position. For example, when transporting objects in the back of a truck, on the top of a vehicle, or on a trailer, it is well known to utilize straps tightly fit against or around the objects to hold them in place during transit. Similarly, it is known to use straps to secure objects or people in position, such as attaching a strap to hunting equipment or to a hunter to secure them against a tree or hang them from a tree stand.

A variety of different mechanisms have been developed to assist in cinching or tightening the retaining portion of the strap such that it has a firm hold on the objects. Many of these mechanisms include a cinching device which allows the tensioned portion of the strap to be shortened by manually pulling on a free end of the strap until it is tight and then locks it in position. While these types of devices are useful, it is sometimes difficult to get the strap tightened as much as needed simply by manually pulling on the free end of the strap. Other mechanisms have been developed, such as mechanical ratchet devices, that enable the user to further mechanically tighten the strap in place. While these devices are also very useful, they can be cumbersome or difficult to operate. In addition, these devices often require two hands to loosen or release tension on the strap which presents difficulties if the user is also trying to hold the items in place so they will not move or fall upon loosening the strap.

### BRIEF SUMMARY OF THE INVENTION

The present invention is directed to a strap assembly having at least one strap or belt secured to a retaining mechanism. The retaining mechanism includes a cinch clamp configured to enable the length of a tensioned portion of one of the straps to be manually adjusted, and a tensioning lever engaged with one of the straps configured to move the strap a distance when the lever is moved from a first position to a second position to further adjust the length of a tensioned portion of the strap. For purposes of this disclosure, the term “tensioned portion” is that portion of one or more straps that is pulled taut or placed under tension when in use and that extends outside the periphery of the retaining mechanism. The combination of the cinch clamp and the tensioning lever enables a user to achieve a tight hold on the items to which the straps are attached and/or against which the straps are engaged.

In one embodiment, the cinch clamp is configured to engage the strap at a location positioned between a free end of one of the straps and a securing end of the strap, with the securing end being configured to be attached to an item (such as to a hook) or secured to another portion of the retaining mechanism. The cinch clamp is configured to engage the strap such that the strap may be moved in a direction that moves the securing end of the strap closer to the cinch clamp (thereby shortening the tensioned portion of the strap), but not moved in a direction that moves the securing end of the strap away from the cinch clamp (thereby lengthening the tensioned portion of the strap). In this manner, the strap may be pulled from the free end of the strap to tighten or shorten the tensioned portion of the strap, but may not be pulled from the securing end of the strap to loosen the tensioned portion of the strap when the cinch clamp is engaged with the strap. The cinch clamp may also include a clamp release configured to disengage the cinch clamp from the strap and allows the securing end of the strap to be moved away from the cinch clamp, thereby loosening or lengthening the tensioned portion of the strap.

In another embodiment, the tensioning lever includes a tensioning pin or bar around which a portion of a strap is positioned such that when the tensioning lever is moved from a first open position to a second closed position, a portion of the strap is pulled by the tensioning bar to move the strap inward of the periphery of the retaining mechanism, thereby tightening or shortening the length of the tensioned portion of the strap. The tensioning lever may also include a lock configured to lock the lever in the closed position to maintain the strap taut, and a lock release configured to enable the tensioning lever to be moved back to the open position to loosen the strap. In a preferred embodiment, when the tensioning lever is in the closed position, the lever serves as a barrier to prevent inadvertant contact with the clamp release on the cinch clamp.

In a preferred embodiment, the retaining mechanism includes a cinch clamp on one end of the mechanism through which a portion of the strap extends, wherein the cinch clamp is biased to engage a portion of the strap such that the securing end of the strap cannot be moved relative to the cinch clamp in a direction away from the cinch clamp (i.e. in a direction loosening the strap), but enables movement of the strap by pulling on the free end of the strap such that the securing end is drawn closer to the cinch clamp. The cinch clamp may be pivoted by pressing a release button to disengage the cinch clamp from the strap and thereby enable the securing end of the strap to be moved away from the cinch clamp to loosen the strap. The retaining mechanism also includes a pivoting handle or lever on the other end of the mechanism, wherein the lever can be moved from an open position to a closed position. The lever includes a tensioning bar or pin around which a portion of the strap is secured or engaged. The tensioning bar or pin is configured to pivot or move with the lever from the open position to the closed position. When in the open position, the pin is positioned closer to the outer end of the retaining mechanism than when in the closed position. In the closed position, the tensioning bar is positioned inward further away from the outer end of the retaining mechanism than when in the open position. Movement of the handle or lever to the closed position moves the tensioning bar inward toward the interior of the retaining mechanism thereby moving the strap inward so as to further tighten the tensioned portion of the strap. In this embodiment, the handle or lever may include a locking mechanism to lock the handle in place with the tensioning bar is in the inner closed position so as to hold the strap tight. The handle or lever also includes a release mechanism to release the lock and enable the handle to open, thereby moving the tensioning bar toward the exterior of the retaining mechanism and loosening the strap. In a most preferred embodiment, when the handle or lever is in the closed position, the lever serves as a barrier to prevent inadvertant contact with the release button on the cinch clamp.

In one embodiment, the strap assembly includes a fixed strap or belt and an adjustable strap or belt. The fixed belt has a first securing end attached to the lever end of the mechanism and a second securing end configured to be secured to another item (such as a hook). The fixed belt extends from the first securing end around the tensioning bar or pin on the lever to the second securing end. The adjustable belt has a free end and securing end configured to be secured to another item (such as a hook). The adjustable belt extends through the cinch clamp such that the clamp is engaged with a portion of the belt when the clamp is in the biased or engaged position. In an alternative embodiment, the strap assembly includes a single unitary strap or belt having one securing end attached to the lever end of the mechanism and a second free end. In this embodiment, the strap extends from the securing end around the pivot bar or pin on the lever and then through the cinch clamp to the free end. In a preferred embodiment, one or more of the securing ends of the belts may include a loop for securing the end to another item.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

FIG. 1A is a perspective view of an illustrative embodiment of a strap assembly with the retaining mechanism in the closed position.

FIG. 1B is a perspective view of the strap assembly of FIG. 1A with a close-up view of the retaining mechanism in the closed position.

FIG. 2 is a perspective view of the strap assembly of FIG. 1 with a close-up view of the retaining mechanism in the open position.

FIG. 3 is a side cross-sectional view of the strap assembly of FIG. 1 with a close-up view of the retaining mechanism in the open position.

FIG. 4 is a side cross-sectional view of the strap assembly of FIG. 1 with a close-up view of the retaining mechanism in the closed position.

FIG. 5 is an exploded perspective view of the cinch claw, cinch pivot pin, and biasing spring of the strap assembly of FIG. 1.

FIG. 6 is a partial side view of the strap assembly of FIG. 1 with a close-up view of the lever handle in the locked position and showing the operation of the release button to unlock the lever handle.

### DETAILED DESCRIPTION OF PREFERRED EMBODIMENT

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

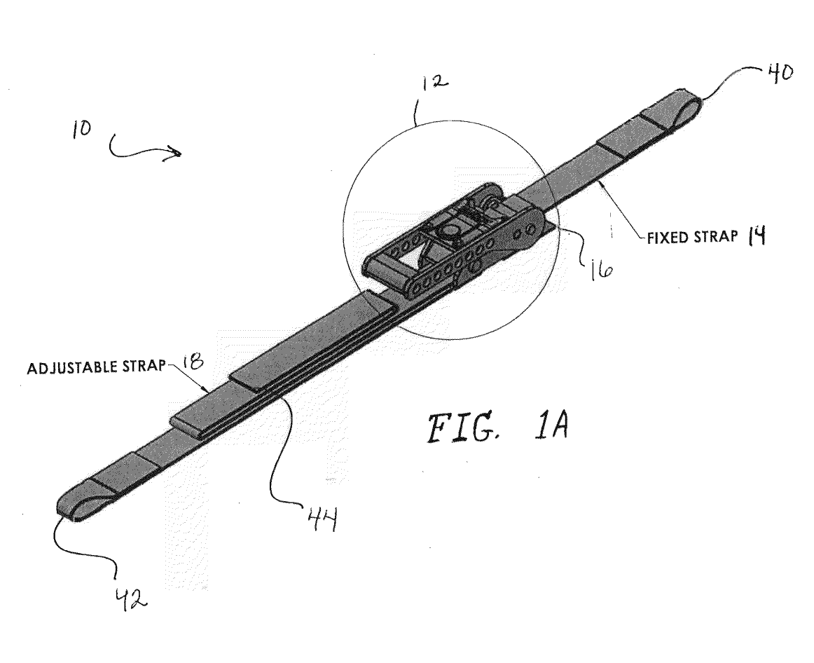

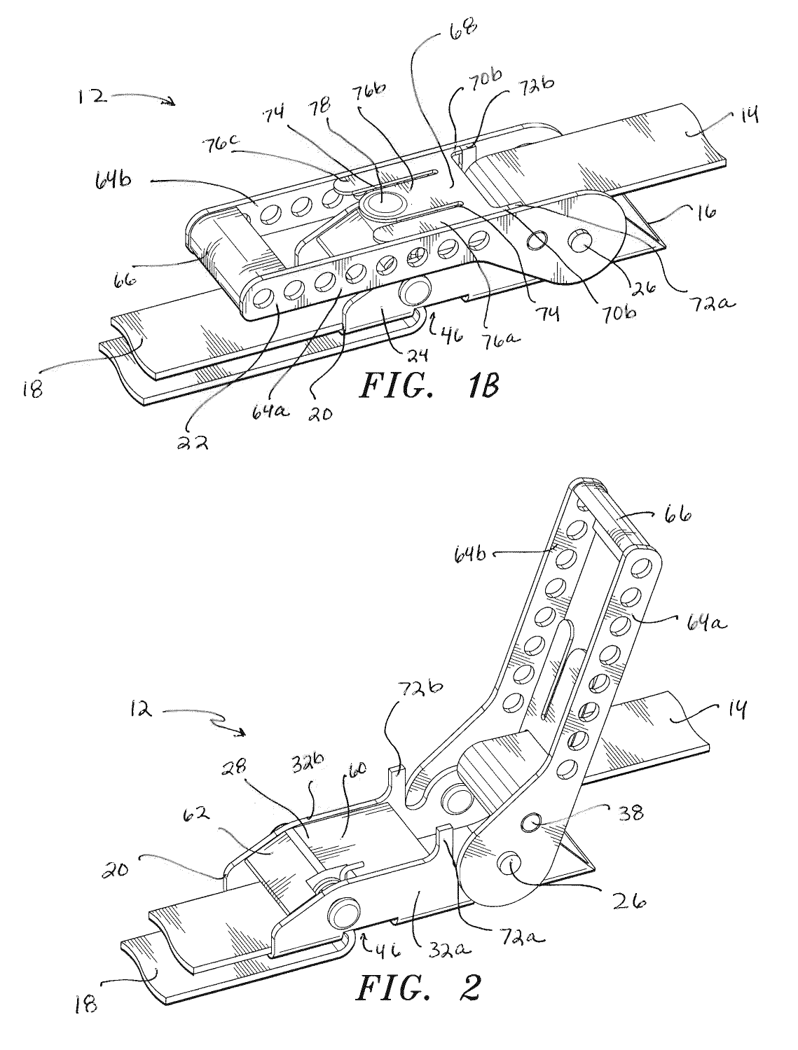

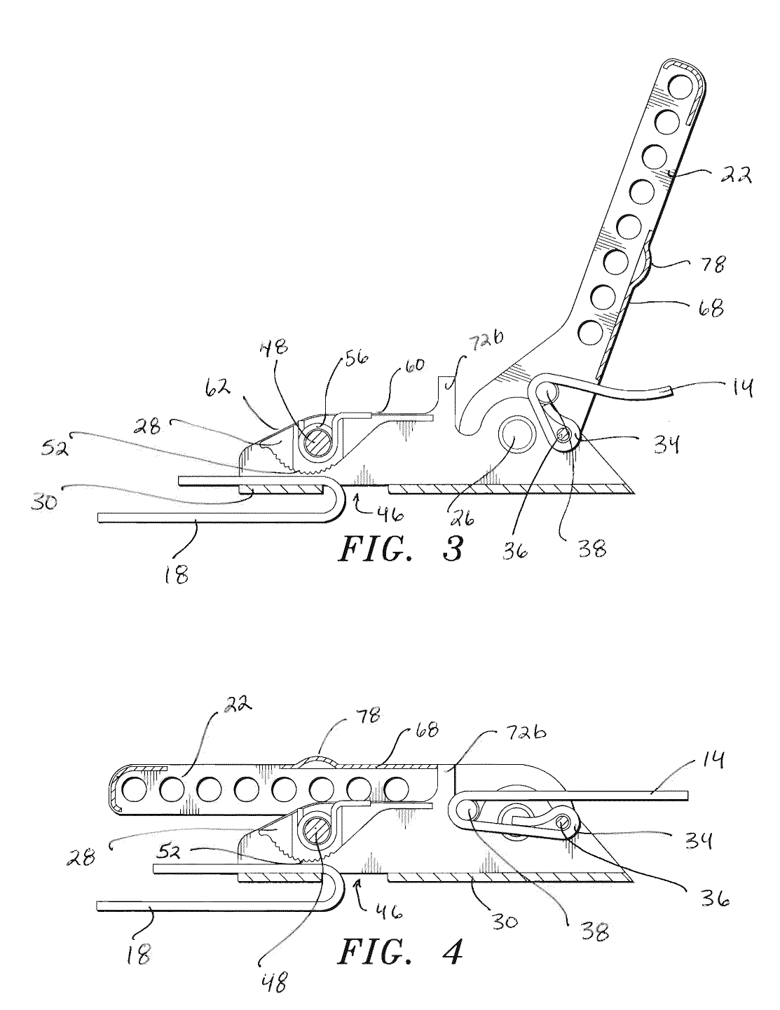

Looking to FIGS. 1 and 2, a strap assembly in accordance with a preferred embodiment of the present invention is generally designated by the numeral 10. Strap assembly 10 includes a retaining mechanism 12 engaged with a fixed belt 14 adjacent the first or rear end 16 of retaining mechanism 12 and engaged with an adjustable belt 18 adjacent the second or front end 20 of retaining mechanism 12. Retaining mechanism 12 includes a lever-type handle 22 pivotally mounted to a base frame 24 along a pivot point 26 adjacent rear end 16 and a rounded wedge-shaped cinch claw 28 pivotally mounted to base frame 24 adjacent front end 20. Base 24 includes a rectangular bottom wall 30 (FIG. 3) and upwardly extending opposed side walls 32a, 32b along each side of the base frame. As best shown in FIG. 3, fixed belt 14 has a looped first securing end 34 secured around securing pin 36 that extends between, and is affixed at each end to, opposed side walls 32 adjacent rear end 16. Fixed belt 14 extends from first securing end 34, under and around the front and top portions of tensioning bar 38 that is secured to lever handle 22 and then back past the rear end 16 of the retaining mechanism to a second securing end 40 (FIG. 1A). Looking to FIG. 1A, second securing end 40 has a loop configured to engage a separate structure such as a hook, a climbing stick, tree stand, camera arm, or other item.

Adjustable belt 18 has a first securing end 42 with a loop configured to engage a separate structure such as a hook, a climbing stick, tree stand, camera arm or other item, and a second free end 44 configured to be grasped for use in manually tightening a tensioned portion of the belt. As best shown in FIGS. 1A and 3, a portion of adjustable belt 18 between a top front portion of bottom wall 30 and the bottom of cinch claw 28 and then through a slot 46 in bottom wall 30 positioned rearward of the lowest point on the cinch claw 28. As discussed more fully below, the bottom of cinch claw 28 and the top front portion of bottom wall 30 together define a cinch clamp that engages the portion of adjustable belt 18 extending therebetween. In this manner, free end 44 of the adjustable belt is positioned on the end of that portion of the belt that extends ahead or forward of cinch claw 28 and securing end 42 is positioned on the end of the belt that extends behind or rearward of cinch claw 28.

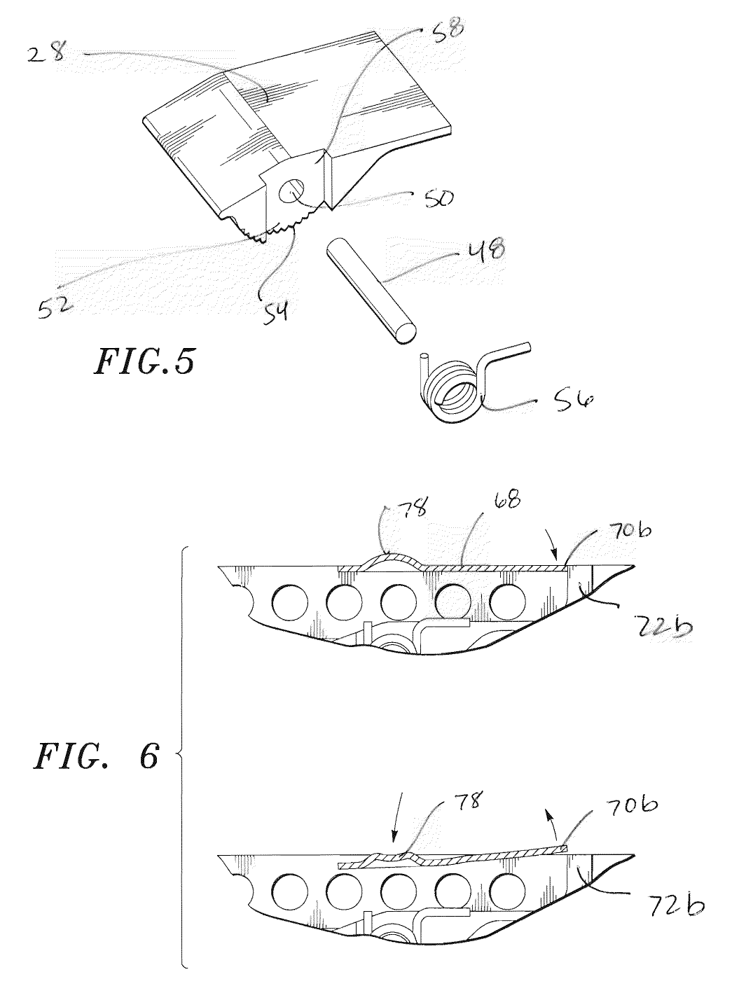

Looking at FIGS. 3, 4 and 5, wedge shaped cinch claw 28 is pivotally engaged with base frame 24 via a cinch pivot pin 48 extending through a cavity 50 in cinch claw 28 and secured at each end to opposed sidewalls 32a, 32b respectively. Cinch claw 28 has a rounded bottom 52 that extends downwardly to a low point positioned forward of slot 46. Rounded bottom 52 includes teeth 54 extending outwardly at an angle generally perpendicular the radius of rounded bottom 52, albeit it is understood that the angle of teeth 54 could be adjusted to enhance engagement of the teeth with the adjustable belt upon movement of the belt in a specific direction. Cinch claw 28 is biased via spring 56 secured around pivot pin 48 within notch 58 along the side of cinch claw 28 adjacent an end of cavity 50, such that the rounded bottom 52 of claw 28 is urged toward engagement with that portion of adjustable belt 18 extending between the bottom of cinch claw 28 and the top of the bottom wall 30 of base frame 24. When in the biased position, the bottom 52 and teeth 54 of cinch claw clamp the belt in position against the bottom wall 30 of base frame 24 with sufficient force or friction to prevent movement of adjustable belt 18 with respect to base frame 24 in a direction toward the securing end 42 of the adjustable belt, but permits movement of adjustable belt 18 with respect to base frame 24 in a direction toward free end 44 of the adjustable belt when the free end is pulled with some force. In this manner, that portion of adjustable belt extending from securing end 42 to the rear of cinch claw 28 (that portion being referred to as a “tensioned portion” of the belt) may be shortened by pulling on the free end of the belt to tighten the tensioned portion of the belt, but that portion may not be lengthened to loosen the belt when the claw is in the biased/engaged position.

This adjustable belt 18 engaged with the retaining mechanism 12 such that when the securing end 42 is pulled or moves away from the cinch claw 28, the strap assembly 10 is loosened (i.e., the length of belt extending from the securing end to the cinch claw increases), and when the securing end 42 is pulled or moved toward the cinch claw 28, the strap assembly 10 is tightened.

Cinch claw 28 has a relatively flat top 60 extending rearward from a center axis of the claw aligned with the lowest point on the rounded bottom, and a downwardly sloped top 62 extending forward of the center axis to a front of the claw. Flat top 60 serves as a release button that may be pressed downward to pivot claw 28 such that bottom 52 of the claw is raised upwardly out of engagement with adjustable belt 18. When in this disengaged state, belt 18 is free to move in both directions and in particular, the tensioned portion of the belt extending rearward of cinch claw 28 to securing end 42 may be lengthened and thereby loosened.

Lever handle 22 has two opposed side arms 64a, 64b extending forward to a front bridge 66 that extends between side arms 64 along the front edge of the handle. A rear bulbous portion of each arm 64a, 64b is pivotally attached to a corresponding rear portion of opposed side walls 32a, 32b respectively about pivot point 26 via pivot bolts, rivets or other means known in the art such that the rear bulbous portion of arms 64a, 64b rest in abutting engagement against the outer surface of the corresponding portions of sidewalls 32a, 32b respectively. Lever handle is pivotally secured with base frame 24 such that the handle 22 may be pivoted upward and rearward to an open position as shown in FIG. 3 or pivoted downward and forward to a closed position as shown in FIG. 4.

Tensioning bar 38 is secured at each end, and extends between, opposed side walls 64a, 64b at a position forward or above pivot point 26. A relatively thin and resilient plate 68 is secured along and between the upper inner edge of side arms 64a, 64b. Plate 68 includes two tabs 70a, 70b extending rearward along the side edges of plate 68 that cooperate with upwardly extending catches 72a, 72b on the base frame 24 to releasably lock the lever handle 22 in the closed position. Specifically, catches 72a, 72b extend upwardly from opposed sidewalls 32a, 32b respectively at a location forward of pivot point 26 and tensioning bar 38. Catches 72a, 72b each have a relatively flat front vertical surface configured to abuttingly engage a front edge surface of tabs 70a, 70b respectively when the handle is in the closed position. In this manner, catches 72 prevent rearward movement of the handle once it is in the closed position such that the handle is locked in place.

Looking to FIG. 1B, top plate 68 has two parallel slots 74 extending from a front of plate 68 toward the rear of plate 68, but ending a distance from the rear edge of plate 68. Slots 74 are presented about a third of the distance inward from each outer side edge of plate 68 to define three finger sections 76a, 76b, 76c. Looking to FIG. 6, a front portion of the middle finger section 76b has an upwardly extending bump 78 that serves as a lock release. Pushing downward on bump 78 causes the midsection of plate 68 to deflect downwardly pushing up the rear tabs 70a, 70b like a spring to a position above the top edge of catches 72a, 72b such that catches 72 no longer block movement of handle 22. Thus, handle 22 can be unlocked and moved from the closed position to the open position by pressing on bump 78 and lifting the handle.

Handle 22, tensioning bar 38, tabs 70, and catches 72 may be configured such that in the closed position, when force is applied to fixed belt 14 in a direction generally away from retaining mechanism 12, handle 22 is even more securely held in the closed position due to the additional force between the tabs 70 and catches 72. The configuration of handle 22 and top plate 68 in this illustrative embodiment also serves to protect the cinch claw 28 when handle 22 is in the closed position to prevent any unwanted release of adjustable belt 18 via inadvertent force on flat top 60 which serves as the release button for cinch claw 28.

In an alternative embodiment, fixed belt 14 and adjustable belt 18 may be integrally formed and/or joined with one another. In such an embodiment, a single strap or belt may be used with a first securing end of the strap engaged with retaining mechanism 12 at the first end 16 thereof via a non-adjustable loop wrapped around tensioning bar 38 on lever 22. The second free end of the belt is passed through slot 46 and under cinch claw 28 such that a portion of the belt between the free end and the securing end is engaged with the cinch clamp thereby forming a loop extending from cinch claw 28 to the first end 16. The loop, which serves as the tensioned portion of the belt, can be tightened or shortened by manually pulling on the free end of the belt and then closing the lever. The loop can be loosened or lengthened by pushing the lock release on the lever, moving the lever to the open position, pushing the release button on the cinch claw and pulling on the loop.

Having described the preferred embodiment for at least one application of the strap assembly 10, an illustrative method of using the strap assembly 10 will now be described. The illustrative method of using the strap assembly 10 described herein applies to an embodiment having a single belt serving as the fixed belt and the adjustable belt 14, 18 combined, with a first securing end thereof fixedly engaged with retaining mechanism 12 via the tensioning bar 38 and a second free end adjustably engaged with the retaining mechanism 12 via cinch claw 28.

After locating an object with which the user desires to engage strap assembly 10, with handle 22 in the open position, the user would wrap the belt 14, 18 around the object and threading the free end of the belt through slot 46 and under cinch claw 28. This creates a loop in the belt that will serve as the tensioned portion of the belt. The cinch claw 28 is configured such that the user may pull the free end in a direction away from the claw 28 to tighten the belt around the object. Once tightened, the user would then pivot handle 22 as far as possible to the open position, thereby moving the tensioning bar 38 as far away as possible from claw 28, which may naturally occur as the user pulls the free end in a direction away from the claw 28 due to the cam-lock configuration of the lever handle 22, base frame 24, and tensioning bar 38.

Once the belt is sufficiently tight, the user may move the handle 22 to the closed position, thereby moving the tensioning bar 38 inward toward the second end 20 of the retaining mechanism. This in turn further tightens the belt around the object due to the cam-lock configuration previously described. As the handle is moved to the closed position, tabs 70 contact (and eventually engage) catches 72 to lock the handle in place. When the handle 22 is in the fully closed position, the engagement between tabs 70 and catches 72 prevent handle 22 from moving inadvertently.

When the user desires to remove the strap from the object, the user may press the release member button 78 downward toward base frame 24, thereby disengaging tabs 70 from catches 72, which allows the user to rotate the handle 22 to the open position. This exposes the cinch claw 28, and the user may now press the cinch release button 60, causing the claw 28 to pivot and release the belt so that the user may pull the tensioned portion of the belt away from the claw.

Where separate fixed and adjustable belts are used, the tensioned portion of fixed belt 14 is that portion of the belt extending from the second securing end 40 attached to an object to the first or rear end of the retaining mechanism. The tensioned portion of adjustable belt 18 is that portion of the belt extending between securing end 42 and the slot 46 or rear side of cinch claw 28.

The present disclosure provides a strap assembly for quickly and easily fastening the strap to an object, which object may include but is not limited to a post and tree. The strap assembly disclosed herein is faster, easier, and quieter to use than competing apparatuses of the prior art. The strap assembly disclosed herein achieves a locking pressure equal to or greater than any easily adjustable competing device of the prior art.

The materials used to construct the strap assembly and various elements thereof will vary depending on the specific application, but it is contemplated that polymers, natural materials, metals and their alloys, and/or combinations thereof will be especially useful for some applications, with stainless steel and aluminum alloy components being most preferred. Accordingly, the above-referenced elements may be constructed of any material known to those skilled in the art or later developed, which material is appropriate for the specific application of the strap assembly, without departing from the spirit and scope of the invention as disclosed and claimed herein.

Having described the preferred embodiments, other features of the strap assembly will undoubtedly occur to those versed in the art, as will numerous modifications and alterations in the embodiments as illustrated herein, all of which may be achieved without departing from the spirit and scope of the invention disclosed herein. Accordingly, the methods and embodiments pictured and described herein are for illustrative purposes only, and the scope of the present disclosure extends to all method and/or structures for securely engaging a belt with an object.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed is:

1. A strap assembly comprising:
at least one strap extending from a free end to a securing end; and
a retaining mechanism secured to said at least one strap, wherein said retaining mechanism comprises a cinch clamp configured to enable the length of a tensioned portion of one of said at least one straps to be manually adjusted, and a tensioning lever configured to move one of said at least one straps a distance when the lever is moved between an open position and a closed position to further adjust the length of a tensioned portion of said one of said at least one straps.

2. A strap assembly according to claim 1, wherein the said cinch clamp is configured to engage the one of said at least one straps at a location positioned between the free end of said strap and the securing end of said strap such that the strap may be moved in a direction that moves the securing end of the strap closer to the cinch clamp but not moved in a direction that moves the securing end of the strap away from the cinch clamp.

3. A strap assembly according to claim 2, wherein said cinch clamp additionally comprises a clamp release configured to disengage the cinch clamp from said one of said at least one straps and allows the securing end of said strap to be moved away from the cinch clamp.

4. A strap assembly according to claim 1, wherein said tensioning lever comprises a tensioning bar around which a portion of said one of said at least one straps is positioned such that when the tensioning lever is moved from the open position to the closed position, a portion of the strap is pulled by the tensioning bar to move the strap inward of a periphery of the retaining mechanism.

5. The strap assembly according to claim 4, wherein the tensioning lever includes a lock for locking said lever in the closed position.

6. The strap assembly according to claim 5, wherein said tensioning lever additionally comprises a lock release configured to enable the tensioning lever to be moved from the closed position to the open position.

7. The strap assembly according to claim 4, wherein the tensioning lever is configured to serve as a barrier to prevent contact with the clamp release when said tensioning lever is in the closed position.

8. A strap assembly comprising:
at least one strap extending from a free end to a securing end; and
a retaining mechanism engaged with said at least one strap, wherein said retaining mechanism comprises a cinch clamp on a first end of said retaining mechanism through which a portion of one of said at least one straps extends, wherein the cinch clamp is biased to engage a portion of the strap such that it cannot move relative to the cinch clamp in a direction toward the securing end of the strap, but enables movement of the strap relative to the cinch clamp in a direction toward the free end of the strap, and a lever on the other end of the mechanism, wherein the lever engages a portion of one of said at least one straps and moves said one of said of at least one straps when the lever is moved from an open position to a closed position.

9. A strap assembly according to claim 9, wherein said cinch clamp may be pivoted to disengage the cinch clamp from said one of said at least one straps and enable movement from the securing end of the strap away from the cinch clamp.

10. A strap assembly according to claim 10, wherein said lever includes a tensioning bar around which a portion of one of said at least one straps is engaged, wherein the tensioning bar is positioned closer to an outer end of the retaining mechanism in the open position than it is when in the closed position.

11. A strap assembly according to claim 11, wherein movement of said lever to the closed position moves said tensioning bar and a portion of said strap inward toward the an interior of the retaining mechanism.

12. A strap assembly comprising:
a fixed strap extending from a first securing end attached to a first end of said mechanism and a second securing end configured to be secured to another item, wherein said fixed strap extends from the first securing end around a portion of a tensioning bar on a lever configured to move the fixed strap inward toward the mechanism upon movement of the lever; and
an adjustable belt extending from a free end to a securing end configured to be secured to another item, wherein said adjustable strap extends through a cinch clamp such that the clamp is engaged with a portion of the adjustable belt when the clamp is in an engaged position to permit movement of the free end of said adjustable strap away from the cinch clamp to reduce the length of a tensioned portion of the strap, but prevents movement of the securing end away from the cinch clamp to lengthen the tensioned portion of the strap.

13. A strap assembly according to claim 12, wherein at least one of said securing ends comprises a loop.

14. A strap assembly according to claim 12, wherein said cinch clamp additionally comprises a clamp release configured to disengage the cinch clamp from said adjustable strap and allows the securing end of said strap to be moved away from the cinch clamp.

15. A strap assembly according to claim 12, wherein said tensioning lever comprises a tensioning bar around which a portion of said fixed strap is positioned such that when the tensioning lever is moved from the open position to the closed position, a portion of the fixed strap is pulled by the tensioning bar to move the strap inward of a periphery of the retaining mechanism.

16. The strap assembly according to claim 15, wherein the tensioning lever includes a lock for locking said lever in the closed position.

17. The strap assembly according to claim 15, wherein said tensioning lever additionally comprises a lock release configured to enable the tensioning lever to be moved from the closed position to the open position.

18. The strap assembly according to claim 16, wherein the tensioning lever is configured to serve as a barrier to prevent contact with the clamp release when said tensioning lever is in the closed position.
